(19) United States
(12) Patent Application Publication
(10) Pub. No.: US 2009/0037621 A1
(43) Pub. Date: Feb. 5, 2009

(54) METHODOLOGY AND CIRCUIT FOR INTERLEAVING AND SERIALIZING/DESERIALIZING LCD, CAMERA, KEYPAD AND GPIO DATA ACROSS A SERIAL STREAM

(76) Inventors: James B. Boomer, Monument, CO (US); Oscar W. Freitas, Cape Elizabeth, ME (US); Steven M. Macaluso, Scarborough, ME (US)

Correspondence Address: CESARI AND MCKENNA, LLP, 88 BLACK FALCON AVENUE, BOSTON, MA, 02210, US

(21) Appl. No.: 12/180,993

(22) Filed: Jul. 28, 2008

Related U.S. Application Data
(60) Provisional application No. 60/953,625, filed on Aug. 2, 2007.

(51) Int. Cl. G06F 13/38

(52) U.S. Cl. 710/60

(57) ABSTRACT

A serializing/deserializing interface is discussed for reducing the number of connections and signals being carried over a flex cable as would be found in a hand held mobile device. In particular the interface interleaves data, multiplexes data and multiplexes control for a number of I/O devices. For example those I/O devices might include an LCD display, a camera, a keypad and a GPIO (general purpose I/O) device.

### RELATED APPLICATIONS

The present application is related to and claims the benefit of a Provisional Application Ser. No. 60/953,625; filed Aug. 2, 2007, of common, title, inventorship and ownership as the present application. This provisional application is incorporated herein by reference.

The present application is a continuation-in-part of and claims the benefit of the filing dates of the following applications that are incorporated herein by reference:

1. “Method and Circuit for Interleaving, Serializing and Deserializing Camera and Keypad Data,” application Ser. No. 12/112,136, filed Apr. 30, 2008, by James B. Boomer and Oscar W. Freitas;

2. “Method and Circuit of Changing Modes Without Dedicated Control Pin,” application Ser. No. 12/112,152, filed Apr. 30, 2008, by James B. Boomer, Oscar W. Freitas, and Steven M. Macaluso; and

3. “Method and Circuit for Capturing Keypad Data, Serializing and Deserializing and Regenerating the Keypad Interface,” application Ser. No. 12/112,176, filed May 3, 2008, by James B. Boomer and Oscar W. Freitas.

The present application is also related to an application entitled “Serializer for Multiple Applications,” application Ser. No. ______, filed ______, 2008, by Jongsoo (Daniel) Cho.

### BACKGROUND OF THE INVENTION

1. Field of the Invention

The present invention relates to multiplexing and serializing/deserializing data from a number of devices across a serial interface.

2. Background Information

I/O devices like keypads and keyboards, cameras, LCD displays, and miscellaneous general purpose I/O (GPIO) devices are often found in mobile hand held devices. These I/O devices, like many microprocessors, typically provide parallel interfaces. In mobile devices, however, some I/O devices are separated by a hinge from a controller microprocessor.

In prior art mobile devices, interconnecting the microprocessor and the I/O devices in a mobile device requires many parallel connections to traverse a flexible cable squeezed into a hinge. A large number of wires is undesirable due to decreased reliability and increased cost.

It would be advantageous to reduce the number of physical wires that traverse the hinge of a folding or sliding mobile phone. Serialization provides one level of wire reduction.

### SUMMARY OF THE PRESENT INVENTION

The present invention provides a reduction of the wires that traverse a flexible cable. The present invention provides an interface for serializing and interleaving data to and from, at least, an LCD display, a device interfaced via a GPIO (general purpose input/output) connection, a camera, an I2C device and a keypad or key board. Further reduction may be achieved, as provided by the present invention, by interleaving multiple sets of parallel data across the same serial wires and by controlling modes without a dedicated control pin or wire.

The serialized data may be interleaved over shared wires where timing intervals may be utilized to mix signals from different devices in a time sequence. For example, during video transmission often there are vertical (VSYNC) and horizontal (HSYNC) syncing pulses where no data is carried on the video data lines. These times may be used by other devices to send serial data. For example keyboard data may be sent during these times where a human operator will not notice any delay. Although expressed as keyboard data, virtually any serial data may be sent during a camera VSYNC or HSYNC time period.

In a like manner, LCD data, GPIO and I2C signals may be multiplexed over common connections (connecting wires). At least part of the control of which of these three data types may be sent may be controlled by a changed clock frequency. For example, if LCD or I2C signals are to be multiplexed, a clock frequency may be used to distinguish the data type being sent. For example, a particular clock frequency may indicate that LCD data is being sent, and a frequency change may command a mode change where I2C signals is being transferred. In this example a frequency detection circuit may be used. When neither LCD nor I2C signals is being sent, GPIO data may be loaded and serially transferred.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIGS. 1A, 1B, 1C, 1D and 1E are block diagram schematics of functional blocks employing the present invention:

FIG. 1F is a timing diagram;

FIG. 2 is a schematic of an internal strobe generation;

FIGS. 3, 4, 5, 6, and 7 are block diagram schematics illustrating the LCD/I2C multiplexing; and

FIG. 8 is a timing chart illustrating frequency comparison to effect mode change.

### DETAILED DESCRIPTION OF AN ILLUSTRATIVE EMBODIMENT

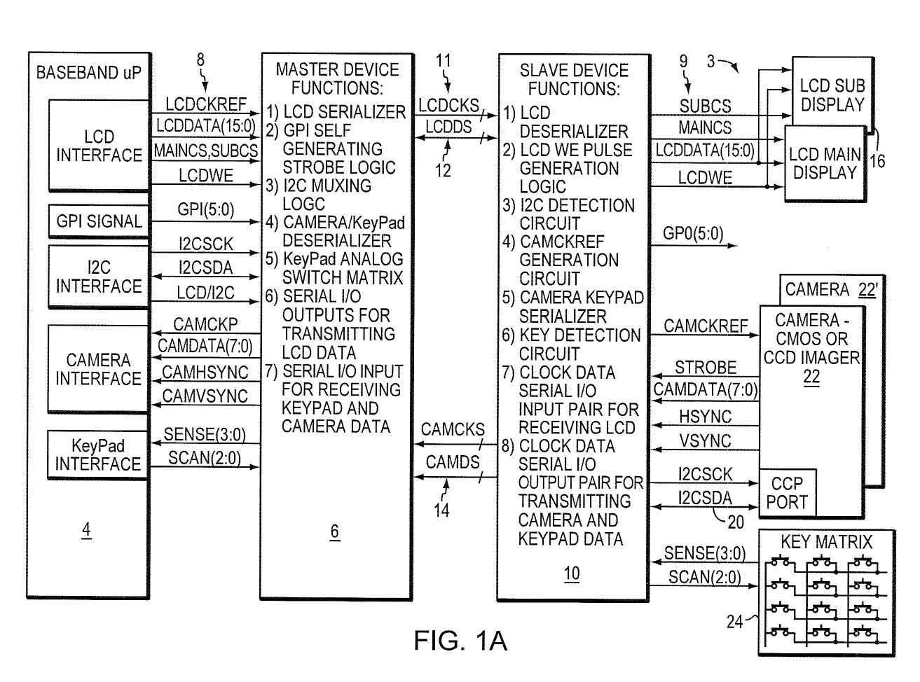

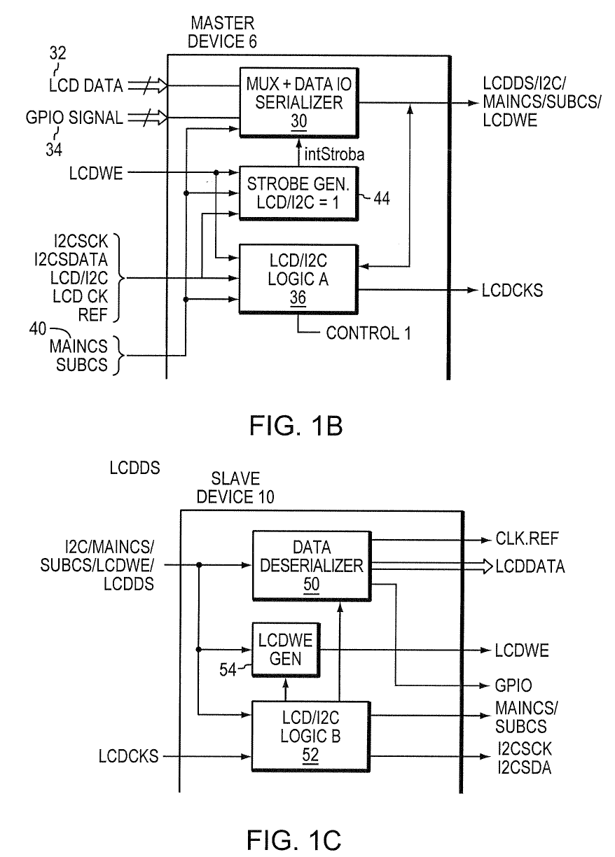

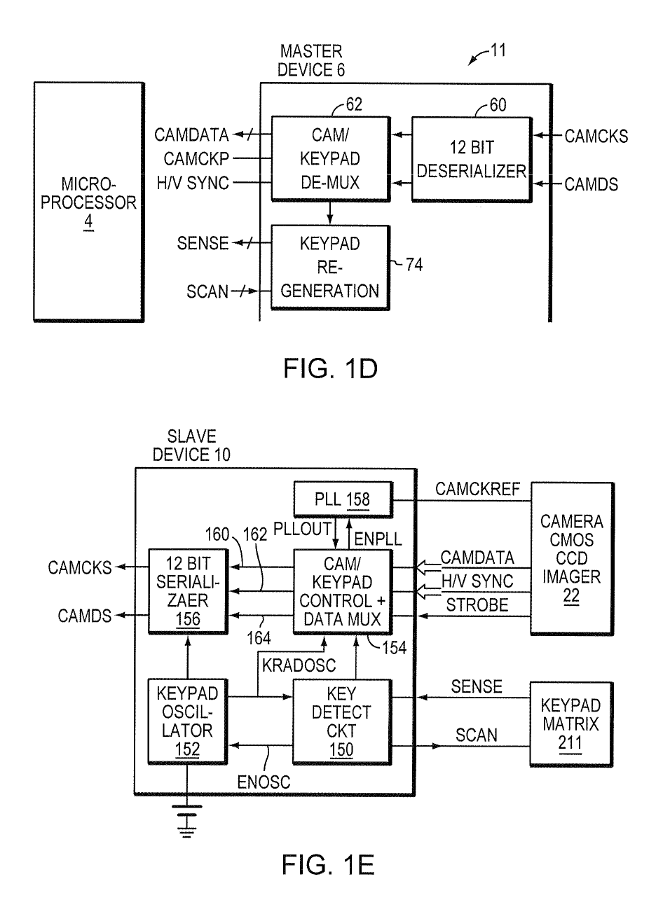

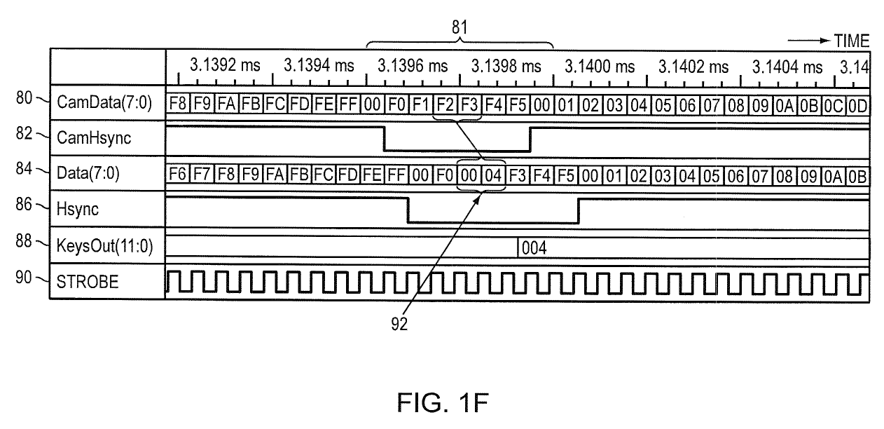

FIG. 1A illustrates a system employing the present invention. In this case a microprocessor 4 has a number for individual parallel I/O ports, each with data, clock and control signals. On the right side of FIG. 1A are the corresponding I/O devices 5. Note that the I/O connections leaving the microprocessor 4 are similar to the I/O connections to the I/O devices 5. In some applications other control connections (not shown) may be employed depending on the devices as would be known to those skilled in the art.

Between the microprocessor 4 and the I/O devices 5, a Master Device 6 and a Slave Device 10 that are connected to each other via a flexible cable 11 designed to squeeze through a hinge. The Master and the Slave Devices have many parallel connections 8 at the microprocessor 4 and at 9 to the I/O devices 5, but only a few connections between the two on the flexible cable 11 that improve reliability and the bending function (fewer wires to bend and break within the hinge).

In FIG. 1A, the present invention provides for sharing the serial connections among LCD signals, GPIO signals and I2C signals. In addition, parallel camera I/O data may be serialized and interleaved with signals from a keypad.

Illustratively, a pair of devices, a Slave 6 and a Master 10, made in accordance with the present invention, serialize and deserialize LCD, GPIO and I2C signals as well as camera and keypad signals. The signals are multiplexed between the signal sources and carried across shared serial interfaces, and may be sent in full duplex or half duplex as desired.

FIG. 1A illustrates the functions within an example of major blocks that embody the present invention. A general purpose microprocessor 4 interfaces with a Master Device 6 via a group of parallel connections 8. The Master Device 6 interfaces with a Slave Device 10 via a flexible cable 11 carrying four serial connections. The first two 12 carry a clock (LCDCKS) and data (LCDDS). These two carry information to and from LCD displays 16, a GPIO interface 18 and an I2C interface 20. The second two 14 carry a camera clock (CAMCKS) and data (CAMDS). These two connections carry information to and from cameras 22 and a keypad 24.

FIG. 1B illustrates in block form the electronic functions between the Master Serializer 6 and the microprocessor 4 re the LCD/GPIO and I2C functions. Sixteen LCD data lines 32, six GPIO data lines 34 and the LCD chip selects 40 (MAINCS—the main LCD display chip select and the SUBCS—a subsidiary LCD display chip select) are loaded into the multiplexer (MUX) data serializer 30 and clocked out on the LCDDS. The LCD chip selects 40, the LCDWE (display write enable), and the I2CSCK (clock), the I2CSDA (data), the LCD/I2C (control) and the LCDCKREF (a reference clock) are input to the LCD/I2C Logic A 36 and the Strobe Gen. 44 that controls the LCD or GPIO data being loaded into and strobed out of the data serializer 30.

FIG. 1C shows the functions and circuit in the Slave Device that correspond to the functions in FIG. 1B. A data deserializer 50 receives either LCD and GPIO or I2C SIGNALS as directed by the LCD/I2C Logic B circuit 52. The LCD/I2C Logic blocks A and B are discussed in more detail below.

FIGS. 1D and 1E illustrate the functions within the Master/Slave Devices 6 and 10 that passes camera, keypad data and control. A 12 bit deserializer 60 receives the CAMCKS (camera clock) and CAMDS (camera/keypad data). A demultiplexer 62 splits the 12 parallel data from the deserializer 60 into camera data and control signals and sense and scan signals recreating the keypad signals. These data are input to the microprocessor 4.

There is a key pad detection circuit 150 that scans the key pad 24 and detects which key is depressed with the aid of an oscillator 152. As known to those skilled in the art, other techniques may be used to detect when a key is depressed. A control and data multiplexer 154 interleaves sending/receiving signals from the key pad and the camera, alternately, in time. Care is taken so that the time restraints on the camera I/O are met while not missing any key pad depressions.

When the key pad 24 key is pressed as sensed by the control and data multiplexer 154 signals from the key detection circuit 150 and the oscillator 152, the key data is sent to a twelve bit serializer 156. The key pad data is serialized and sent over the CAMDS along with a clock signal CAMCKS that provides timing for the Master Deserializer 60 to properly receive the key pad signals. The keypad data may be formatted or encoded in binary, hex, etc. as the designed might determine.

When the camera needs service, a phase locked loop, PLL 158, provides a clock, CAMCKREF to the camera 22. The CAMDATA lines, HSYNC, VSYNC, and the strobe are sent directly to the controller and data multiplexer 154. The controller data multiplexer 154 interfaces with the serializer 156 via, illustratively, twelve parallel data lines 160, a strobe 162 and a SERCK (serial clock) 164. Note that a PLL (not shown) may be implemented in the LCD path to provide a reference clock for serialization.

In one illustrative operation, when the camera is deasserting a HSYNC or VSYNC (horizontal or vertical synchronization), the camera data is invalid. During these times the key pad data may be transferred without corrupting either the key pad or the camera operations. The present invention uses the HSYNC, illustratively, time period to interleave or multiplex the keypad data and the camera data. The combined data is serialized and sent over the DS line with the CKS signal in the flex cable.

The Master Deserializer 60 receives and deserializes the multiplexed key pad and camera data into parallel data and separates the two with demultiplexer 62. The key pad data is regenerated into parallel form 74 recognized by a microprocessor. The camera parallel data is also regenerated into a parallel form recognized by the microprocessor 4 as shown in FIG. 1D.

In one embodiment, an additional connection may be included in the DS group that signals when keypad or camera data is being passed. Other methods may be used as known to those skilled in the art, for example the first byte passed on the DS lines might always be a mode indicator that indicates a given amount of camera (or keypad) data follows. Other techniques are known in the art.

FIG. 1F illustrate a typical set of camera and keypad waveforms that illustrate the present invention. Along the top is a TIME sequence that might be found for a typical camera—CMOS or CCD imager. The first row 80 of data signals each of one byte shown in hex format are illustrative data signals from the camera. The grouping of these signals 81 indicates a HSYNC deasserted, horizontal synchronization, time period. The camera data signals, while HSYNC 82 is low, are indicated by bytes F0, F1, F2, F3, F4 and F5. The data on these lines is meaningless with respect to the camera. However, the HSYNC time is used in the present invention to send keypad data to the micro-processor via the Master Serializer/Deserializer. Note that Data 84 and HSYNC 86 are offset in time occurring later that the traces at 80 and 82. This time difference illustrates the delay times through the Master Serializer electronics. Also, note that during the HSYNC 86, the F2 and F3 data bytes from the camera have been replaced by the two byte groups, 00 and 04, indicated as item 92. The next row 88 shows the keypad data on twelve bits or hex 004. Only 1.5 bytes are used by the keypad so the leading four bits are made equal to zero so that bytes 00 04 are sent to the Deserializer. In this embodiment, the keypad data is sent replacing the F2 and F3 bytes of camera data during the HSYNC, but any of the data bytes during the HSYNC may be used as long as they are consistent. Keypad data may also be transferred during the VSYNC as would be known to those skilled in the art.

In preferred embodiments, the system may be operated in several modes. In a first mode, low speed key pad, the PLL 58 is disabled, and the key oscillator 52 travels through the key pad matrix when a key is depressed levels on the serial lines. The key pad data is passed using LVCMOS (low Voltage CMOS).

A second mode, high speed camera/key pad, enables the PLL 158 (which becomes locked). The key pad data is captured and passed when the HSYNC signal 86 is low. Camera data is passed when HYSYNC 86 is high.

A third mode, high speed camera, passes no camera data. But key pad data is passed by the controller and a key pad data multiplexer provides a low, pseudo HSYNC signal.

As would be known to those skilled in the art, other timing arrangements as well as other multiplexing arrangements may be used to advantage with the present invention. For example, the present disclosure uses an oscillator to detect and decode a key depression, but logic signals may be used, including voltage signals and/or current signals. In addition, there are many microprocessors that may be used to advantage. Additionally very large silicon integration circuits with dedicated functions may be used, as well as one chip computers.

A PLL is disclosed in this illustrative example, but, as known to those skilled in the art, operations without PLLs may be used. For example crystal clocks or the equivalent depending on the camera timing requirements, and other types of timing circuits may be used to advantage.

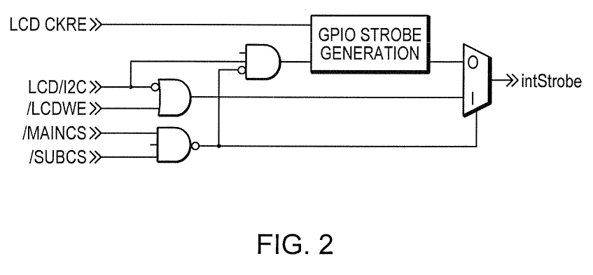

Referring back to FIGS. 1B and 1E, FIG. 2 illustrates one embodiment of the Strobe Generator 44. When LCD/I2C is true, then LCDWE will generate an internal strobe (intStrobe) to load data into the MUX Data Serializer 30. Data in the Data Serializer 30 is always sent when the LCDWE pulses. If no data is being sent to the main or subordinate display, the GPIO strobe is generated selecting and loading and sending the GPIO data. If either of the MAINCS or SUBCS is true, the GPIO strobe generation is disabled.

Timing is designed so that the GPIO data is sent once for every sixteen CKREF cycles. Alternatively, GPIO data may be sent only when the GPIO data changes.

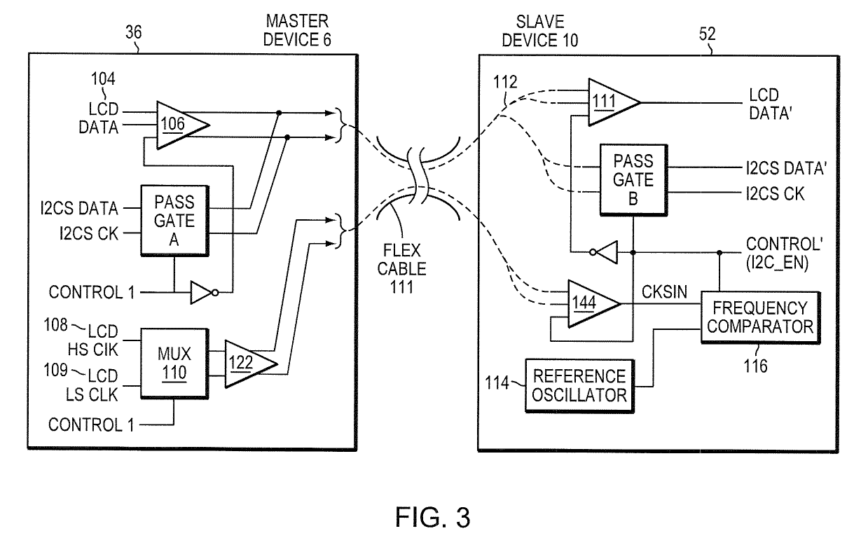

The operations of LCD/I2C Logic A and B from FIGS. 1B ad 1C are illustrated in FIGS. 3 to 7. The mechanism is to alter the clock signals for the LCD data for dual use when the LCD data is not being sent. In this case I2C signals and I2C CLK may be transferred, instead of LCD data.

FIG. 3 shows a generic SENDER (in the Master Device 6) and RECEIVER (in the Slave Device 10) with the interconnecting flex cable 11. A control signal is generated by a computer system (not shown) that generates the CONTROL 1 signal. In one condition, the CONTROL 1 may be used to pass LCD data 104 through a differential driver 106, or in the other condition to pass I2C signals and an I2C clock through the pass gate A to the flex cable 11. A high speed 108 or a low speed 109 LCD is input to the multiplexer (MUX) 10 that drives a buffer 122 that, in turn, drives the flex cable 11. The CONTROL1 signal controls the MUX 110 to pass the LCD HS CLK (high speed clock) or the LCD LS CLK(low speed clock) input onto the flex cable. The speed of the clock signal is used by the circuitry to determine if the data is LCD or I2C SIGNALS.

The LCD DATA′ or the I2C signals' and CLK′ (clock) is received by buffer 111 or the PASSGATE B as determined by the CONTROL′ signal.

The LCD CLK′ is received by the buffer 144 which outputs the CKSIN signal. The CKSIN is compared to a REF. OSCILLATOR 114 at the FREQ. The COMPARATOR 116 outputs the CONTROL′ that determines which signals are received. The CONTROL′ is identical with the I2C_EN signal described later.

Note in FIG. 3, the logic structures are illustrative for understanding, while a more detailed representative implementation is discussed in the other drawings. Also, note that the I2C PASS GATES A and B are bidirectional and so the I2C signals and CLK may be passed in both directions.

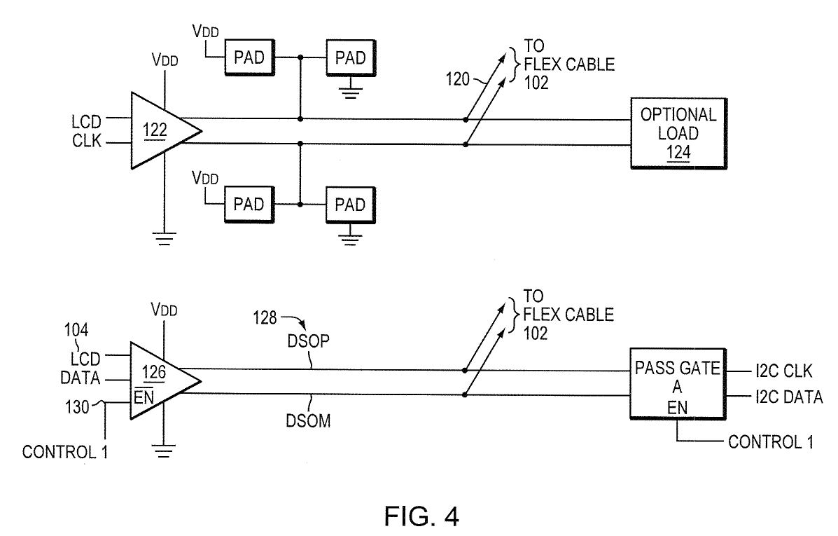

FIG. 4 illustrates an embodiment for the electronics at the SENDER 36 of FIG. 3 driving the output pins 120 that connect to the flex cable 102. These output pins are shown connecting to a flex cable 11, but they might be going directly to another integrated circuit. Differential clock signals, LCD CLK, are driven by a transmitter 122 onto the output pins 120. As shown for the output pins of transmitter 122, each pin is connected to PADs that provide Electrostatic Discharge protection (ESD). All the pins, contacts and wires in this embodiment may be so protected, although not shown in the FIGS.

“LCD” represents liquid crystal display or any other type of display, and “CLK” represents clock. The dummy load 124 is optional depending on the application and simply presents a known load cable termination on the output pins 120 that connect to the flex cable.

Differential LCD DATA 104 is driven by a transmitter 126 onto differential DSOP and DSOM pins 128 that connect to the flex cable 102. When LCD DATA 104 is being sent DSOP and DSOM represent the positive and negative, respectively, signals of the differential LCD DATA.

However, when PASS GATE A is enabled, by CONTROL1, I2C CLK is presented onto DSOP and an I2C signals is presented onto DSOM. When I2C signals are enabled by CONTROL1 onto the lDSOP and DSOM lines, the LCD DATA 104 is blocked by transmitter 126, illustratively, being disabled by the CONTROL1—(the logic inverse of CONTROL1). Here CONTROL1 is a mode determining signal that may be set by a computer system (not shown) that interfaces with the SENDER. Since LCD DATA or I2C signals are placed onto the DSOP and DSOM lines, the output of buffer 126, when not enabled, must not load the PASS GATE A, and the PASS GATE A, when not enabled, must not load the buffer 126.

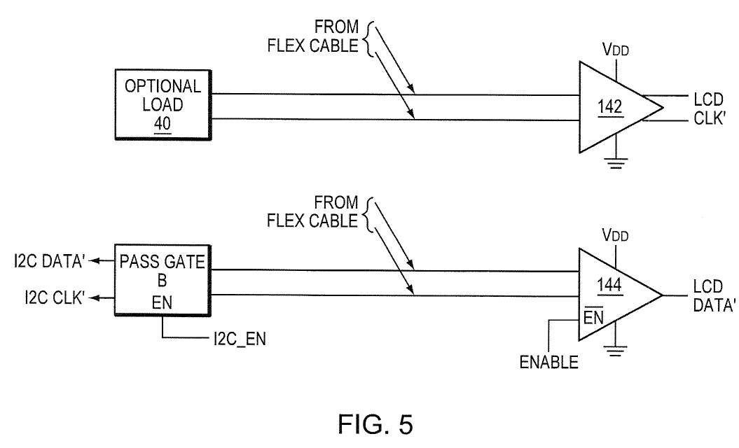

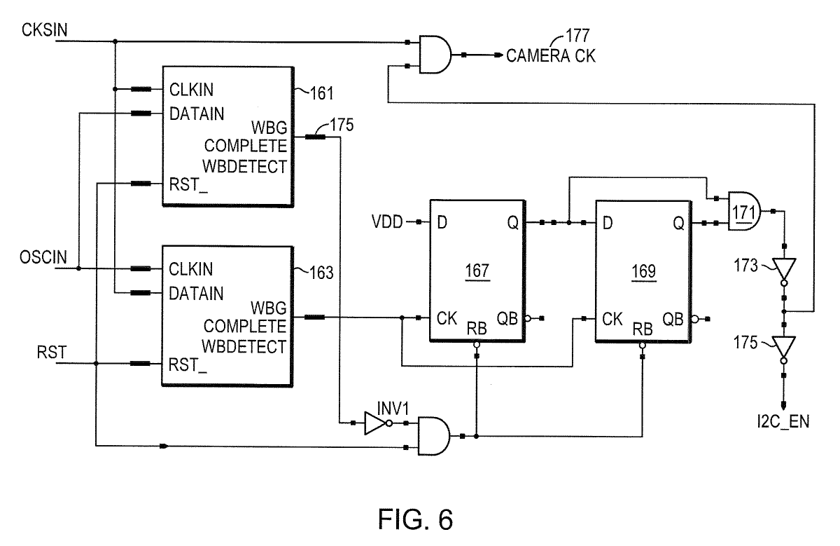

FIG. 5 illustrates the RECEIVER of FIG. 3. The LCD CLK is received by an optional cable termination load 140 and the buffer 142. A buffered LCD CLK′ signal is presented to other circuitry (not shown) in the RECEIVER. One of the differential LCD CLK signals, CKSIN, is presented to the frequency comparator of FIG. 6, below.

Coincidentally, the LCD DATA (or the I2C CLK and the I2C signals) is received by the buffer 144 from the flex cable. If I2C_EN is true, I2C signals are received and passed through the PASS GATE B to other circuitry (not shown). If LCD DATA is received they are buffered 144 and a single ended LCD DATA′ is presented to the following circuitry (not shown). An ENABLE signal, if desired, may be generated to prevent the LCD DATA′ signals from traversing the buffer 144.

FIG. 6 illustrates a circuit that functions as the FREQUENCY COMPARATOR 116 of FIG. 3. Frequency detectors (formed as parallel missing pulse detectors) 161 and 163 compare the received clock signal CKSIN to a reference oscillator signal OSCIN. The output is the I2C_EN signal that directs the I2C signals traversing the flex cable or the LCD signals to the proper receiving circuitry (not shown).

In some applications, a camera clock 17 output may provide the CAMCKREF of FIG. 1A.

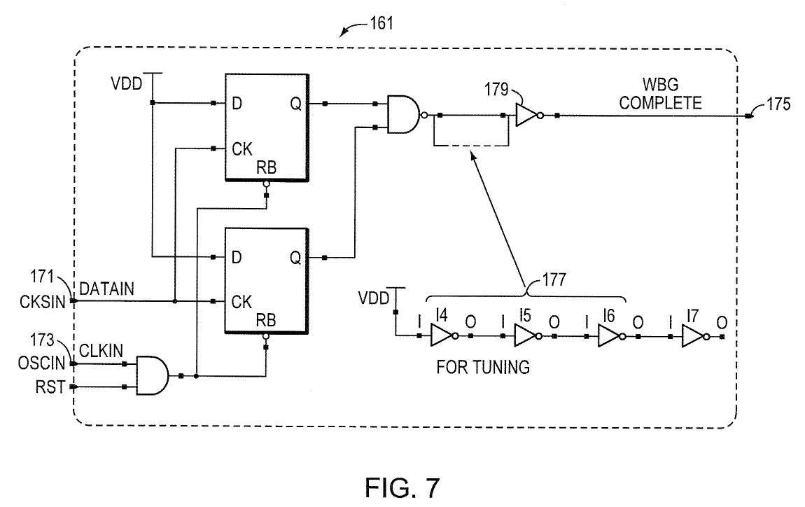

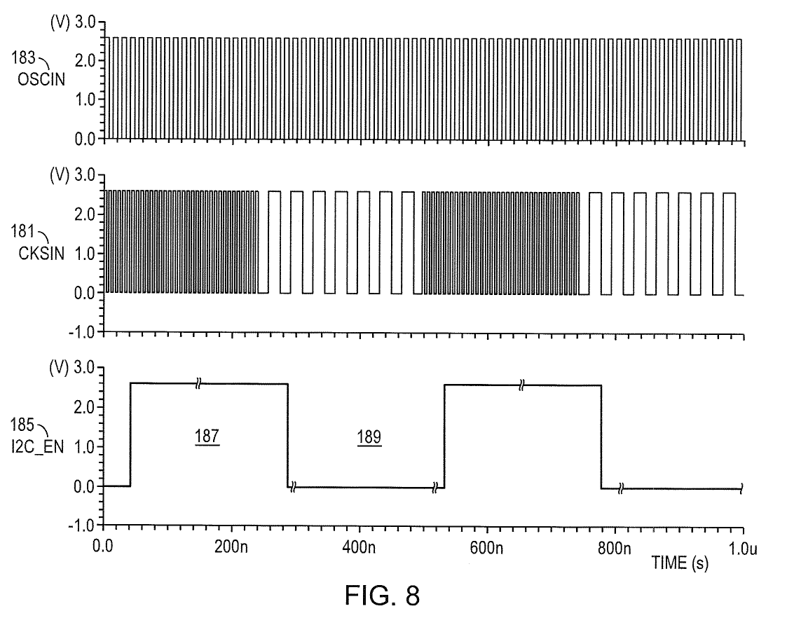

FIG. 7 illustrates a preferred embodiment of the detector 161 of FIG. 6. Item 163 is identical except the order of the OSCIN and CKSIN are reversed. CKSIN is input to the DATAIN 171 and OCSIN to the CLKIN 173 of item 161 of FIG. 7. These inputs operate to provide an output WBG_COMPLETE 175. The output 175 outputs a signal indicating a missing pulse with respect to the input signals 171 and 175. The inverter chain 717 provides programmable delays that may be added before the inverter 179 to tune the delay as might be required in applications. When the two missing pulse detectors are logically joined, the frequency of the LCD CLK′ is compared to the reference oscillator.

FIG. 8 illustrates a simulation of a serial clock input frequency. CKSIN, 81 compared to a reference oscillator signal, OSCIN, illustratively set at 75 MHz 183. The frequency detection signal 185 illustrates when CKSIN is higher 187 and lower 189 compared to OSCIN 183.

The present invention provides an advantage, in one preferred embodiment, of using frequency detection for setting different modes. Illustratively, the mode change is between LCD and I2C modes, or from transferring LCD signal to transferring I2C signals across a flex cable, while maintaining the usefulness of the frequency's original intent. There is, at least, one less pin needed on an integrated circuit and/or one less wire needed on the flex cable.

The frequency detection approach provides real time monitoring and multiplexing bidirectional I2C control and LCD data shared over a common serial bus with protection against electromagnetic interference (EMI).

Although the implementation is shown herein as electronic circuits, those skilled in the art will understand that other electronic circuits may perform the same functions, and that systems employing software, firmware and/or hardware and combinations thereof may be used to advantage to accomplish equivalent functions.

What is claimed is:

1. A system for transferring information, the information comprising high speed data and control and low speed data and control, the system comprising:
a first serializer that receives and sends high speed and low speed parallel data, serial data and control signals from a microprocessor or controller;
a first deserializer that sends and receives high speed and low speed parallel data, serial data and control signals to a microprocessor or controller
a second serializer that receives and sends high speed and low speed parallel data, serial data and control signals from a group of I/O devices;
a second deserializer that sends and receives high speed and low speed parallel data, serial data and control signals to a group of I/O devices;
first connections between the first serializer and the first or the second deserilizer, and second connections between the second sterilizer and the first of the second deserializer, wherein serial information is transferred therebetween; and
a clock having two frequencies that is transferred to the second serializer/deserializer, via the second serial connections.

2. The system of claims 1 further comprising a first multiplexer that accepts high speed parallel and low speed parallel or serial information and that interleaves and outputs the higher speed and the lower speed into a serial time sequence and transfers that serial time sequence to the first serializer, and further comprising a second multiplexer that accepts high speed parallel and low speed parallel or serial information and that interleaves and outputs the higher speed and the lower speed into a serial time sequence and transfers that serial time sequence to the second serializer.

3. The system of claim 2 wherein the data transfers are in full duplex.

4. The system of claim 2 wherein the high speed and the low speed information is distinguished by detecting different clock frequencies.

5. The system of claim 1 wherein the high speed serial data includes synchronization signals from a camera.

6. The system of claim 5 wherein the low speed data is transferred during the horizontal and vertical synchronization signals.

7. The system of claim 1 wherein the group of I/O devices includes one or more of LCD displays, GPIO devices, I2C devices, a camera and keypads.

8. The system of claim 7 wherein when the I/O device is a keypad matrix sending parallel data, that data is serialized and deserialized wherein the keypad matrix parallel data is regenerated.

9. The system of claim 1 wherein one of the I/O devices is a GPIO device, wherein GPIO information is transferred when the information content is changed by the microprocessor or controller generating an internal strobe.

10. The system of claim 1 wherein one of the I/O devices is a GPIO device, wherein GPIO information is serialized into serial data bits wherein the serial data bits are sent with a strobe signal.

11. A process for transferring information, the information comprising high speed data and control and low speed data and control, the process comprising the steps of:
first serializing and receiving and sending high speed and low speed parallel data, serial data and control signals from a microprocessor or controller;
first deserializing and sending and receiving high speed and low speed parallel data, serial data and control signals from a microprocessor or controller;
second serializing and receiving and sending high speed and low speed parallel data, serial data and control signals from a group of I/O devices;
second deserializing and sending and receiving high speed and low speed parallel data, serial data and control signals from a group of I/O devices;
first transferring serial information between the first and the first or the second deserializer;
second transferring serial information between the second and the first or the second deserializer;
transferring a clock signal having two frequencies to the second deserializer via a second serial connection.

12. The process of claim 11 further comprising the steps of:
first multiplexing that accepts high speed parallel and low speed parallel or serial information and that interleaves and outputs the higher speed and the lower speed into a serial time sequence and transfers that serial time sequence to the first serializer, and
second multiplexing that accepts high speed parallel and low speed parallel or serial information and that interleaves and outputs the higher speed and the lower speed into a serial time sequence and transfers that serial time sequence to the second serializer.

13. The process claim 12 further comprising the step of transferring the data in full duplex.

14. The process of claim 12 further comprising the step of distinguishing high and low speed data by detecting different clock frequencies.

15. The process of claim 11 wherein the high speed serial data synchronization signals are from a camera.

16. The process of claim 15 wherein the low speed information is during the synchronization signals

17. The process of claim 16, wherein when the I/O device is a keypad matrix having parallel data that is serialized and sent to a deserializer, further comprising, after deserializing, the step of regenerating the keypad matrix parallel data.

18. The process of claim 11 wherein, when one of the I/O devices is a GPIO device, further comprising the step of: transferring the information by generating a strobe.
